(19) United States
(12) Patent Application Publication
(10) Pub. No.: US 2009/0060598 A1
(43) Pub. Date: Mar. 5, 2009

(54) IMAGE FORMING METHOD

(75) Inventors: Masaaki KONDO, Tokyo (JP); Shingo FUJIMOTO, Tokyo (JP); Takao YAMANOUCHI, Kanagawa (JP); Ryuichi HIRAMOTO, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/187,068

(22) Filed: Aug. 6, 2008

(30) Foreign Application Priority Data
Aug. 27, 2007 (JP) JP2007-219612

(51) Int. Cl. G03G 15/14

(52) U.S. Cl. 399/297

(57) ABSTRACT

Disclosed is an image forming method including steps of primary transferring the toner image formed on the photoreceptor to an intermediate transfer material, secondary transferring the toner image on intermediate transfer material, and cleaning remaining toner on the photoreceptor, in which method the toner contains abrasive agent particles adhered to a toner mother particle comprising a resin and a colorant, abrasive agent particles having a particle diameter of 80-300 nm and Mohs' hardness of 5 or more in an amount of parts by weight of 100 parts by weight of toner mother particle, and the intermediate transfer material has a hardness measured by nanoindentation method of 3-10 GPa.

This application is based on Japanese Patent Application No. 2007-219612 filed on Aug. 27, 2007, the entire content of which is hereby incorporated by reference.

### TECHNICAL FIELD

This invention is directed to an electrophotographic image forming method.

Recently, high image quality, colorization, high durability are demanded on an image forming method employing small particle size toner in which toner image is transferred from an intermediate transfer material to transfer material after the primary transfer from a photoreceptor to the intermediate transfer material.

There were problems that transfer efficiency of toner image from the intermediate transfer material to the transfer material was insufficient and a toner image of high quality was not obtained in an image forming method in which, after a toner image of four-color small particle size toners was primary transferred from the photoreceptor to the intermediate transfer material, an image of four colors was simultaneously transferred secondary to the transfer material.

There was disclosed means to provide an inorganic layer, for example, an oxide layer such as silicon oxide, on a surface of the intermediate transfer material for a purpose of improving the transfer efficiency of toner image from the intermediate material to the transfer material (Patent Document 1).

It became enable that a toner image of four colors transferred simultaneously with high transfer efficiency by employing the intermediate transfer material having an inorganic layer on its surface.

However, the surface having the inorganic layer is so hard and therefore filming of wax in the toner or minute toner particles on the intermediate transfer material surface can not be removed by a cleaning blade, and there are new problems that filming accumulates for large amount of printing.

A low temperature fixing toner has been used in view of energy saving in recent years. The low temperature fixing toner is apt to generate filming because of low glass transition point, and generation of filming becomes a big problem. Problems of degraded transfer efficiency, an image with streak deficiency or uneven image are caused at a portion of filming.

There is difference of abrasion resistance of the surface of the intermediate transfer material between a film generated portion and a portion without film generation, there became a problem that an edge of a cleaning blade is caught at a high resistance portion and causes blade warp or edge nick.

It is disclosed that an image forming apparatus in which an abrasive agent is supplied to a surface of the intermediate transfer material to abrade the intermediate transfer material so as to reducing the abrasion resistance as well as removing filming (Patent Document 2).

(Patent Document 1): JP-A H09-212004

(Patent Document 2): JP-A 2000-231280

It is necessary to provide newly a supplying device of abrasive agent for supplying the abrasive agent to the intermediate transfer material to remove filming adhered to its surface, and this is a problem because the image forming apparatus becomes larger in size and requires additional cost. Further it is difficult to remove filming on whole surface because abrasive agent is difficultly supplied uniformly on the whole surface of the intermediate transfer material.

### SUMMARY OF THE INVENTION

An object of the invention is to provide an image forming method by which filming or cleaning deficiency tends not to occur and high quality print images having no empty line or extra line is obtained continuously even when a plenty of sheets (e.g., 10,000 sheets) is printed at high temperature high humidity circumstances (e.g., 30° C., 80% RH).

A preferable embodiment of this invention will be described.

An image forming method includes steps of

forming a toner image on a photoreceptor,

primary transferring the toner image on the photoreceptor to an intermediate transfer material,

secondary transferring the toner image on intermediate transfer material, and

cleaning remaining toner on the photoreceptor,

wherein the toner comprises particles (A) adhered to a toner mother particle comprising a resin and a colorant, the particles (A) having a particle diameter of 80-300 nm and Mohs' hardness of 5 or more in an amount of 0.1-2.0 parts by weight with reference to 100 weight by weight of toner mother particle, and

the intermediate transfer material comprises a substrate and an inorganic layer provided on the substrate, and a hardness measured by nanoindentation method is 3-10 GPa.

The toner preferably has a glass transition point of 20-45° C.

### BRIEF DESCRIPTION OF DRAWINGS

FIG. 1: Conceptual sectional schematic view of an example of a measuring device employing a nanoindentation method.

FIG. 2: Schematic view of an example of a measuring device employing a nanoindentation method.

FIG. 3: typical load-displacement curve obtained by a nanoindentation method.

FIG. 4: Diagram showing a contacting situation between an indenter and a sample.

FIG. 5: Schematic diagram of a manufacturing apparatus to produce an intermediate transfer member.

FIG. 6: Schematic diagram of another manufacturing apparatus to produce an intermediate transfer member.

FIG. 7: Schematic diagram of a first plasma film-forming apparatus to produce an intermediate transfer member employing plasma.

FIG. 8(a) and FIG. 8(b): Schematic diagram showing an example of the roll electrode.

FIG. 9(a) and FIG. 9(b): Schematic diagram showing an example of fixed electrodes.

FIG. 10: Cross-sectional schematic view of an example of a color image forming apparatus.

### DETAILED DISCLOSURE OF THE INVENTION

This invention provides an image forming method by which filming or cleaning deficiency does not occur and high quality print images having no empty line or extra line is obtained continuously even when a plenty, of sheets is printed at high temperature high humidity circumstances.

An image forming method employing an intermediate transfer material having an inorganic layer has been investigated not to cause filming or cleaning deficiency even when a plenty of sheets (e.g., 10,000 sheets) is printed at high temperature high humidity circumstances (e.g., 30° C., 80% RH).

It has been found that an image forming method can be obtained by employing a toner having abrasive agent particles (particles (A)) on its surface. Filming or cleaning deficiency does not occur and high quality print images having no empty line or extra line is obtained continuously even when a plenty of sheets is printed at high temperature high humidity circumstances by this image forming method.

The partial filming or cleaning deficiency caused on the surface of the intermediate transfer material is guessed to be prevented because of the following reasons.

A toner having abrasive agent on its surface is got between the cleaning blade and the intermediate transfer material when remaining toner is removed by the cleaning blade, and the surface of the intermediate transfer material is rubbed by the abrasive material on the toner. The remaining toner adhered on the surface of the intermediate transfer material is removed when the intermediate transfer material is rubbed, and simultaneously, an edge portion of the cleaning blade cleaned by the abrasive material on the toner. The surface of the intermediate transfer material is cleaned uniformly for a plenty sheets of printing continuously, and as its result.

The image forming method of this invention comprises steps of toner image forming on a photoreceptor, primary transferring the toner image to an intermediate transfer material, secondary transferring the toner image on the intermediate transfer material to a transfer material, and cleaning remaining toner on the intermediate transfer material.

The intermediate transfer material used in this invention is described.

The intermediate transfer material has an inorganic layer has a hardness of 3-10 GPa measured by nanoindentation method. The inorganic layer preferably has a thickness of 100-1,000 nm. A contact angle of the surface of the inorganic layer measured against methylene iodide is preferably 30-60°.

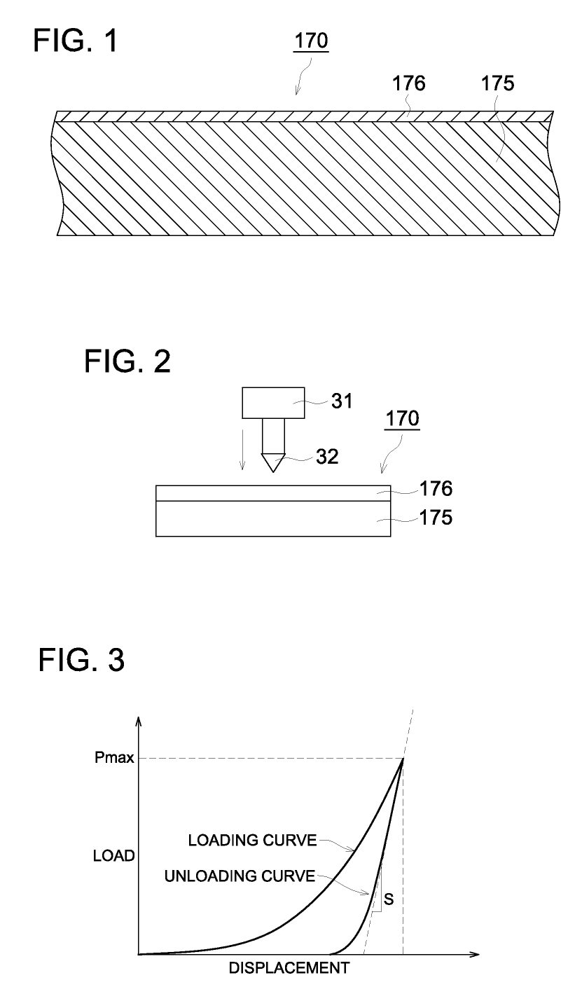

FIG. 1 shows a conceptual sectional view of layer arrangement of an example an intermediate transfer material Symbols 170, 175 and 176 show an intermediate transfer material, a substrate and an inorganic layer, respectively in FIG. 1.

The substrate is preferably a seamless belt or a drum, composed of resin material in which an electroconductive material is dispersed. A thickness of the belt is preferably 50-700 μm, and drum is preferably 1 mm or more. The substrate is preferably a flexible seamless belt in this invention.

The inorganic layer is preferably at least one of a silicon oxide or metal oxide film formed via plasma CVD. Practical example includes a metal oxide film such as silicon oxide, silicon nitride oxide, silicon nitride, titanium oxide, titanium nitride oxide, titanium nitride and aluminum oxide, and silicon oxide film is preferable among them. Inorganic compound of their mixture is also preferably used.

The inorganic layer is provided one layer or more.

### Thickness of Inorganic Layer

Thickness of the inorganic layer is 100-1,000 nm, preferably 150-500 nm, more preferably 200-400 nm.

The inorganic layer having above mentioned thickness has good durability, good surface strength, good adhesiveness or resistance to folding, whereby abrasion is difficultly generated when thick transfer paper is used, deterioration of transfer ratio or uneven transfer would not be observed with large quantity printing, cracking or peeling would not occur, and it is preferred in view of productivity as film can be formed shorter period.

Thickness is measured using a measuring instrument Model MXP21 manufactured by MacScience Inc. Practically copper is employed as a target of the X-ray source, and operation is performed at 42 kV with 500 mA. A multi-layer film parabolic mirror is used as an incident monochrometer. A 0.05 mm×5 mm incident slit and a 0.03 mm×20 mm light receiving slit are employed. According to the 2θ/θ scanning technique, measurement is conducted at a step width of 0.005° in the range from 0 to 5°, 10 seconds for each step by the FT method. Curve fitting is applied to the reflectivity curve having been obtained, using the Reflectivity Analysis Program Ver. 1 of MacScience Inc. Each parameter is obtained so that the residual sum of squares between the actually measured value and fitting curve will be minimized. From each parameter, the thickness and density of the lamination layer can be obtained.

The property such as surface energy and hardness of the intermediate transfer material will be described.

### Surface Energy

The surface energy is represented by a contact angle against methylene iodide.

Contact angle of the inorganic layer against methylene iodide is preferably 30-60°, more preferably 30-50°. Occurrence of filming can be minimized because of good releasing ability from toner, and transfer defect is prevented with such contact angle.

The contact angle of methylene iodide is determined five times employing a contact angle meter CA-V, produced by Kyowa Interface Science Co., Ltd. Subsequently, the determined values are averaged and each of the average contact angles is obtained. Determination is carried out in an ambience of 20° C. and 50% relative humidity.

### Hardness

Hardness is represented by a value measured via nanoindentation method.

Hardness of the inorganic layer measured by a nanoindentation method is 3-10 CPa, preferably 4-6 GPa. Generation of injury is inhibited by making the hardness measured via nanoindentation method 3 CPa or more, and abrasion of cleaning blade is inhibited when 10 GPa or less.

The method of measuring hardness with a nanoindentation method is a method of calculating plastic deformation hardness from the value obtained by measuring the relationship between a load and push-in depth (amount of displacement) while pushing a very small diamond indenter into a thin film.

In the case of a film thickness of specifically 1 μm or less, it is a feature that no crack on the thin film tends to be generated during push-in, together with no dependence on the substrate property. This is generally usable for measuring matter properties of a very thin film.

FIG. 2 is a schematic view of an example of a measuring device employing a nanoindentation method.

In FIG. 2, 31 is a transducer, 32 diamond Berkovich indenter having an equilateral-triangular tip shape, 170 an intermediate transfer material, 175 a substrate and 176 an inorganic layer.

The amount of displacement can be measured to an accuracy of nanometer while applying a load in μN by this measuring device, employing transducer 31 and diamond Berkovich indenter 32 having an equilateral-triangular tip shape. A commercially available “NANO Indenter XP/DCM” (manufactured by MTS Systems Corp./MTS NANO Instruments, Inc.) is usable for this measurement.

FIG. 3 shows a typical load-displacement curve obtained by a nanoindentation method.

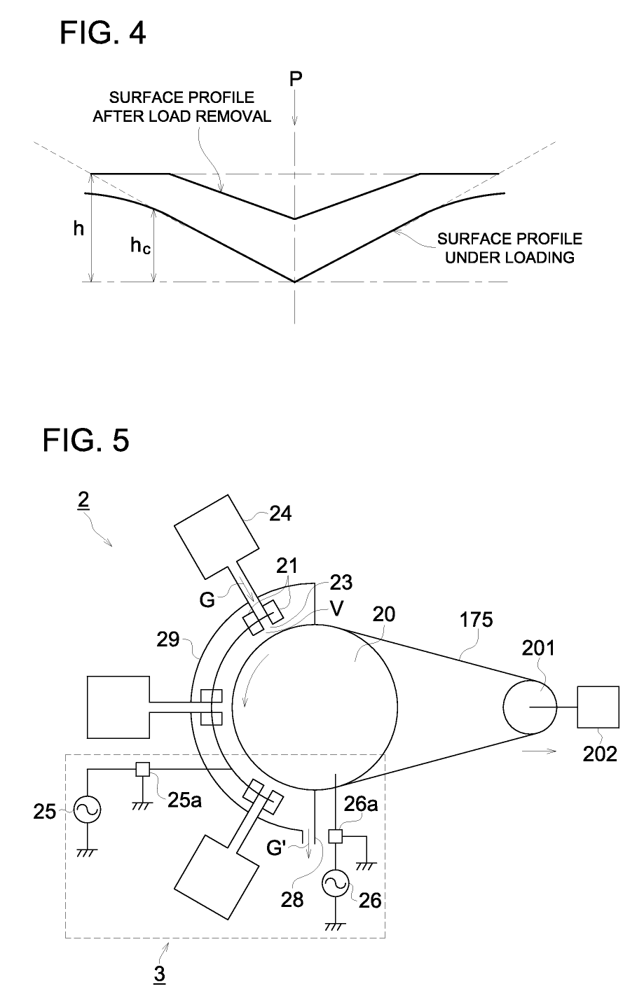

FIG. 4 is a diagram showing a contacting situation between an indenter and a sample.

Hardness H is determined from the following equation.

H=Pmax/A, wherein Pmax is the maximum load, that is the load at which displacement reaches saturated point when load is applied to an indenter, and A is the contact projection area between the indenter and the sample.

Contact projection area A is expressed by the following equation, employing h_{c} in FIG. 4.

A=24.5 h_{c}², where h_{c}, expressed by the following equation (3), is shallower than total push-in depth h because of elastic indentation of the periphery surface of a contact point as shown in FIG. 3.

h_{c}=h−hₛ Equation (3)

where hₛ indicating an indentation amount caused by elasticity is expressed by the following equation (4), using a load curve slope after pushing in an indenter, i.e., slope S in FIG. 3), and an indenter shape.

hₛ=ε×P/S Equation (4)

where ε is a constant concerning the indenter shape to be 0.75 in the case of a Berkovich indenter.

Hardness of the inorganic layer 176 formed on substrate 175 can be measured employing a measuring device with such the nanoindentation method.

### Measure Condition

Apparatus: NANO Indenter XP/DCM (manufactured by MTS Systems Corp.)

Indenter: Diamond Berkovich indenter having an equilateral-triangular tip

Circumstances: 20° C., 60% RH

Sample: An intermediate transfer material cut in size of 5 cm×5 cm

Maximum load: 25 μN

Pushing Speed: Speed to reach Maximum load 25 μN for 5 sec. Load is applied proportional to time.

Measurement was conducted at 10 points in each sample, and the average value is made as hardness measured via nanoindentation method.

An example of an intermediate transfer member will be described.

The intermediate transfer member has an inorganic layer on a surface of a substrate. It is preferred the inorganic layer is formed by a plasma chemical vapor deposition (CVD) method which can form uniform layer within a short time with compact apparatus.

### Substrate

A preferable example of the substrate is a seamless belt composed of a resin containing electro-conductive agent dispersed therein. Examples of the resin usable for the belt include so-called engineering plastic materials such as polycarbonate, polyimide, polyetherether ketone, polyvinylidene fluoride, an ethylenetetrafluoroethylene copolymer, polyamide, polyphenylene sulfide and so forth. Particularly preferable examples are polycarbonate, polyimide, and polyphenylene sulfide.

Carbon black can also be used as the conductive agent, and neutral or acidic carbon black can be used as the carbon black. The conductive filler may be added in such a way that volume resistance and surface resistance are in the predetermined range, depending on kinds of the employed conductive filler. The consumption amount of the conductive filler is commonly 10-20 parts by weight, and preferably 10-16 parts by weight with respect to 100 parts by weight of resin material. Substrate can be manufactured by a conventional method. For example, a resin as a material is dissolved in an extruder, and rapidly cooled via extrusion with a ring die or a T-die to prepare it.

The substrate may be subjected to such surface treatment as corona treatment, flame treatment, plasma treatment, glow discharge treatment, surface roughening treatment and chemical treatment.

A primer layer may be formed between surface layer 176 and substrate 175 in order to improve adhesion. Primers used for the primer layer include a polyester resin, such as an isocyanate resin, a urethane resin, an acrylic resin, an ethylene vinyl alcohol resin, a vinyl-modified resin, an epoxy resin, a modified styrene resin, a modified silicon resin, alkyl titanate and so forth can be used singly or in combination with at least two kinds. An additive can also be added into these primers. The above-described primer can be coated on a substrate employing a conventional method such as a roll coating method, a gravure coating method, a knife coating method, a dip coating method, a spray coating method or the like, and be primed by removing a solvent, a diluent and so forth via drying. The above-described primer preferably has a coating amount of 0.1-5 g/m² (dry state).

### Preparation of Inorganic Layer

An apparatus, method and using gas in the case of forming a surface layer of an intermediate transfer member of the present invention via atmospheric pressure plasma CVD will be described.

FIG. 5 is a schematic diagram of a manufacturing apparatus to produce an intermediate transfer member.

Manufacturing apparatus 2 of an intermediate transfer member is a direct type in which the electric discharge space and the thin film depositing area are substantially identical, which forms surface layer 176 on substrate 175, includes: roll electrode 20 that rotatably supports substrate 175 of endless belt-shaped intermediate transfer member 170 and rotates in the arrow direction; driven roller 201; and atmospheric pressure plasma CVD device 3 which is a film-forming device to form surface layer 176 on the surface of substrate 175.

Atmospheric pressure plasma CVD device 3 includes: at least one set of fixed electrode 21 disposed along the outer circumference of roll electrode 20; electric discharge space 23 which is a facing region between fixed electrode 21 and roll electrode 20 where electric discharge is performed; mixed gas supply device 24 which produces mixed gas G of at least a raw material gas and a discharge gas to supply mixed gas G to discharge space 23; electric discharge container 29 which reduces air flow into, for example, discharge space 23; first power supply 25 connected to roll electrode 20; second power supply 26 connected to fixed electrode 21; and gas exhaustion section 28 for used exhausting gas G′.

Mixed gas supply device 24 supplies a mixed gas of a raw material gas and nitrogen gas or a rare gas such as argon gas, into the discharge space, in order to form a film possessing at least one layer selected from an inorganic oxide layer, an inorganic nitride layer and an inorganic carbide layer.

Driven roller 201 is pulled in the arrow direction by tension-providing unit 202 and applies a predetermined tension to substrate. The tension-providing unit releases providing of tension, for example, during replacement of substrate, allowing easy replacement of substrate.

First power supply 25 provides a voltage of frequency ω1, second power supply 26 provides a voltage of frequency of ω2, and these voltages generate electric field V where frequencies ω1 and ω2 are superposed in discharge space 23. Electric field V makes mixed gas G at plasma state to deposit a film (surface layer) on the surface of substrate, corresponding to the raw material gas contained in mixed gas G.

Surface layer may be deposited in lamination employing the mixed gas supply devices and the plural fixed electrodes disposed on the downstream side with respect to the rotation direction of the roll electrode, among the plural fixed electrodes, so as to adjust the thickness of surface layer 176.

Surface layer 176 may be deposited employing the mixed gas supply devices and the fixed electrodes disposed on the downstream side with respect to the rotation direction of the roll electrode, among the plural fixed electrodes, while another layer, for example, a adhesive layer to improve adhesion between surface layer and substrate, may be formed by the other mixed gas supply devices and fixed electrodes disposed on the upper stream side.

Further, in order to improve adhesion between surface layer and substrate, gas supply devices to supply gas, such as argon gas or oxygen gas, and fixed electrodes may be arranged on the upstream side of the fixed electrodes and the mixed gas supply devices that form surface layer, so as to conduct a plasma treatment and thereby activating the surface of substrate.

As described above, an intermediate transfer belt being an endless belt is tension-supported by a pair of rollers; one of the pair of rollers is used for one of a pair of electrodes; at least one fixed electrode as the other electrode is provided along the outer circumferential surface of the roller which works as the one electrode; an electric filed is generated between the pair of electrodes at an atmospheric pressure or an approximately atmospheric pressure to perform plasma discharge, so that a thin film is deposited and formed on the surface of the intermediate transfer member. Thus, it is possible to provide an intermediate transfer member exhibiting high transferability, high cleaning performance and high durability.

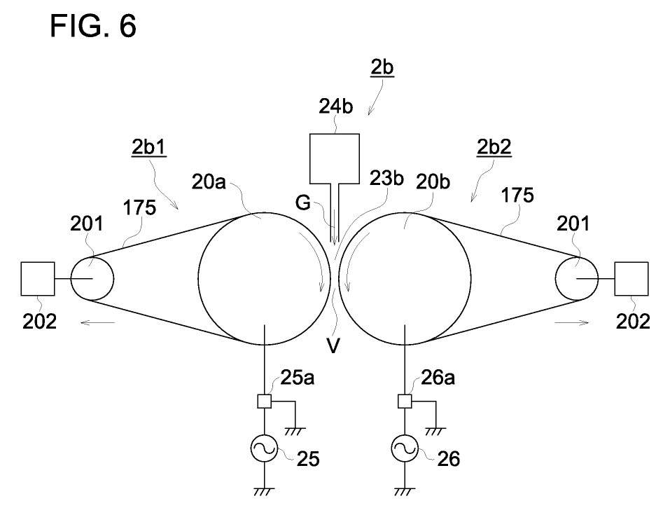

FIG. 6 is a schematic diagram of another manufacturing apparatus to produce an intermediate transfer member.

Another manufacturing apparatus 2b for an intermediate transfer member forms a surface layer on each of plural substrates simultaneously, and mainly includes plural film-forming devices 2b1 and 2b2 each of which forms a surface layer on each of the substrate surfaces.

Second manufacturing apparatus 2b, which is modification of a direct type, that performs electric discharge between facing roll electrodes to deposit a thin film, includes: first film-forming device 2b1; second film-forming device 2b2 being disposed in a substantial mirror image relationship at a predetermined distance from first film-forming device 2b1; and mixed gas supply device 24b that produces mixed gas G of at least a raw material gas and a discharge gas to supply mixed gas G to electric discharge space 23b, mixed gas supply device 24b being disposed between first film-forming device 2b1 and second film-forming device 2b2.

First film-forming device 2b1 includes: roll electrode 20a and driven roller 201 that rotatably support a substrate 175 of an endless belt shaped intermediate transfer member and rotate it in the arrow direction; tension-providing unit 202 that pulls the driven roller 201 in the arrow direction; and first power supply 25 connected to roll electrode 20a. Second film-forming device 2b2 includes: roll electrode 20b and driven roller 201 that rotatably support substrate 175 of an intermediate transfer member in an endless form and rotate it in the arrow direction; tension-providing unit 202 that pulls driven roller 201 in the arrow direction; and second power supply 26 connected to roll electrode 20b.

Further, second manufacturing apparatus 2b includes electric discharge space 23b where electric discharge is performed in a facing region between roll electrode 20a and roll electrode 20b.

Mixed gas supply device 24b supplies a mixed gas of a raw material gas, and nitrogen gas or a rare gas such as argon gas, into discharge space 23b, in order to form a film having at least one layer selected from an inorganic oxide layer, an inorganic nitride layer, and an inorganic carbide film.

First power supply 25 provides a voltage of frequency ω1, second power supply 26 provides a voltage of frequency of ω2, and these voltages generate electric field V where frequencies ω1 and ω2 are superposed in discharge space 23b. Electric field V excites mixed gas G to make plasma state. Surfaces of substrates of first film-forming device 2b1 and second film-forming device 2b2 are exposed to excited mixed gas as plasma state, so as to deposit and form respective films (surface layers) on the surfaces of substrate of first film-forming device 2b1 and substrate of second film-forming device 2b2 simultaneously, corresponding to the raw material gas contained in the excited mixed gas as plasma state.

Facing roll electrode 20a and roll electrode 20b are disposed at a predetermined distance between them.

Embodiments of the atmospheric pressure plasma CVD apparatus by which surface layer is formed on substrate will be described.

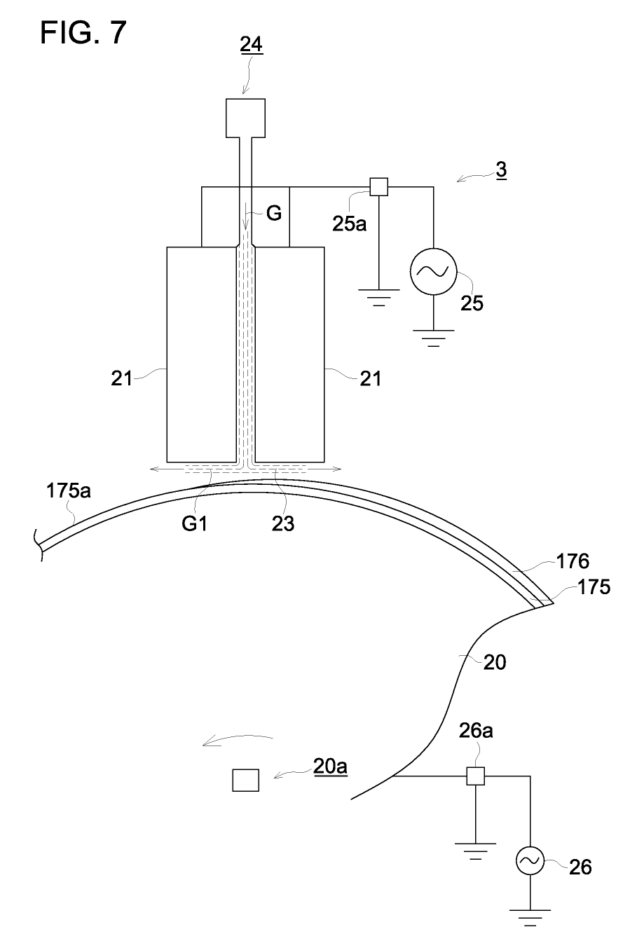

FIG. 7 is a partial view in which the dashed area in FIG. 5 is mainly extracted.

FIG. 7 is a schematic diagram of a first plasma film-forming apparatus to produce an intermediate transfer member employing plasma.

An example of an atmospheric pressure plasma CVD apparatus which is preferably used to form inorganic layer will be described, referring to FIG. 7.

Atmospheric pressure plasma CVD apparatus 3 includes at least one pair of rollers for rotatably supporting a substrate, which can be loaded and unloaded, and rotationally drive the substrate, and includes at least one pair of electrodes for performing plasma discharge, wherein one electrode of the pair of electrodes is one roller of the pair of rollers, and the other electrode is a fixed electrode facing the one roller through the substrate. Atmospheric pressure plasma CVD apparatus 3 is an apparatus of manufacturing an intermediate transfer member and exposes the substrate to plasma generated in the facing area between the one roller and the fixed electrode so as to deposit and form the foregoing surface layer. Atmospheric pressure plasma CVD device 3 is preferably used in the case of employing nitrogen gas as discharge gas, for example, and applies a high voltage via one power supply, and applies a high frequency via another power supply so as to start discharging stably and perform discharge continuously.

Atmospheric pressure plasma CVD apparatus 3 includes mixed gas supply device 24, fixed electrode 21, first power supply 25, first filter 25a, roll electrode 20, drive unit 20a for rotationally driving the roll electrode in the arrow direction, second power supply 26, and second filter 26a, and performs plasma discharge in discharge space 23 to excite mixed gas G of a raw material gas with a discharge gas, and exposes substrate surface 175a to excited mixed gas G1 so as to deposit and form surface layer 176 on the substrate surface.

The first high frequency voltage of frequency of ω1 is applied to fixed electrode 21 from first power supply 25, and a high frequency voltage of frequency of ω2 is applied to roll electrode 20 from second power supply 26. Thus, an electric field is generated between fixed electrode 21 and role electrode 20 where frequency ω1 at electric field intensity V₁ and frequency ω2 at electric field intensity V₂ are superposed. Current I₁ flows through fixed electrode 21, current I₂ flows through roll electrode 20, and plasma is generated between the electrodes.

The relationship between frequency ω1 and frequency ω2, and the relationship between electric field intensity V₁, electric field intensity V₂, and electric field intensity IV that starts discharge of discharge gas satisfy ω1<ω2, and satisfy V₁≧IV>V₂ or V₁>IV≧V₂, wherein the output density of the second high frequency electric field is at least 1 W/cm².

It is preferable that at least electric field intensity V₁ applied from first power supply 25 is 3.7 kV/mm or higher, and electric field intensity V₂ applied from second high frequency power supply 60 is 3.7 kV/mm or lower, since electric field intensity IV to start electric discharge of nitrogen gas is 3.7 kV/mm.

As first power supply 25 (high frequency power supply) applicable to first atmospheric pressure plasma CVD apparatus 3, any of the following commercially available power supplies can be used.

| Applied | | | | |
|---|---|---|---|---|
| Power | | | | |
| supply | Manufacturer | Frequency | | Product name |
| A1 | Shinko Electric Co., | 3 | kHz | SPG3-4500 |
| | Ltd. | | | |
| A2 | Shinko Electric Co., | 5 | kHz | SPG5-4500 |
| | Ltd. | | | |
| A3 | Kasuga Electric | 15 | kHz | AGI-023 |
| | Works, Ltd. | | | |
| A4 | Shinko Electric Co., | 50 | kHz | SPG50-4500 |
| | Ltd. | | | |
| A5 | Haiden Laboratory | 100 | kHz* | PHF-6k |
| A6 | Pearl Kogyo Co., | 200 | kHz | CF-2000-200k |
| | Ltd. | | | |
| A7 | Pearl Kogyo Co., | 400 | kHz | CF-2000-400k |
| | Ltd. | | | |
| A8 | SEREN IPS | 100-460 | kHz | L3001 |

As second power supply 26 (high frequency power supply), any of the following commercially available power supplies can be used.

| Applied | | | | |
|---|---|---|---|---|
| Power | | | | |
| supply | Manufacturer | Frequency | | Product name |
| B1 | Pearl Kogyo Co., | 800 | kHz | CF-2000-800k |
| | Ltd. | | | |
| B2 | Pearl Kogyo Co., | 2 | MHz | CF-2000-2M |
| | Ltd. | | | |
| B3 | Pearl Kogyo Co., | 13.56 | MHz | CF-5000-13M |
| | Ltd. | | | |
| B4 | Pearl Kogyo Co., | 27 | MHz | CF-2000-27M |
| | Ltd. | | | |
| B5 | Pearl Kogyo Co., | 150 | MHz | CF-2000-150M |
| | Ltd. | | | |
| B6 | Pearl Kogyo Co., | 20-99.9 | MHz | RP-2000-20/100M |
| | Ltd. | | | |

Regarding the above described power supplies, the power supply marked * is an impulse high frequency power supply of Haiden Laboratory (100 kHz in continuous mode). High frequency power supplies other than the power supply marked * are capable of applying only continuous sine waves.

Regarding the power supplied between the facing electrodes from the first and second power supplies, a power (output density) of at least 1 W/cm² is supplied to fixed electrode 21 so as to excite discharge gas, and plasma is generated to form a thin film. The upper limit of the power to be supplied to fixed electrode 21 is preferably 50 W/cm², and more preferably 20 W/cm². The lower limit is preferably 1.2 W/cm². Herein, the discharge area (cm²) means the area of the range where discharge is generated at the electrode.

The output density can be improved while maintaining uniformity of the high frequency electric field by supplying roll electrode 20 with a power (output density) of at least 1 W/cm². Thus, plasma with highly even density can be generated, which improves both a film-forming rate and film quality. The power is preferably at least 5 W/cm₂. The upper limit of the power to be supplied to roll electrode 20 is preferably 50 W/cm².

Herein, waveforms of high frequency electric fields are not specifically limited, and can be in continuous oscillation mode of a continuous sine wave form called a continuous mode, and also in intermittent oscillation mode called a pulse mode performing ON/OFF intermittently, either of which may be employed. However, at least, the high frequency to be supplied to roll electrode 20 preferably has a continuous sine wave to obtain a dense film exhibiting good quality.

First filter 25a is provided between fixed electrode 21 and first power supply 25 to allow a current to flow easily from first power supply 25 to fixed electrode 21, and the current from second power supply 26 is grounded to inhibit a current running from second power supply 26 to first power supply 25. Second filter 26a is provided between roll electrode 20 and second power supply 26 to allow a current to flow easily from second power supply 26 to roll electrode 20, and the current from first power supply 21 is grounded to inhibit a current running from first power supply 25 to second power supply 26.

It is preferable to employ electrodes capable of applying a high electric field, and maintaining a uniform and stable discharge state. For durability against discharge by a high electric field, the dielectric material described below is coated on at least one surface of each of fixed electrode 21 and roll electrode 20.

In the above description, regarding the relationship between the electrode and the power supply, second power supply 26 may be connected to fixed electrode 21, and first power supply 25 may be connected to roll electrode 20.

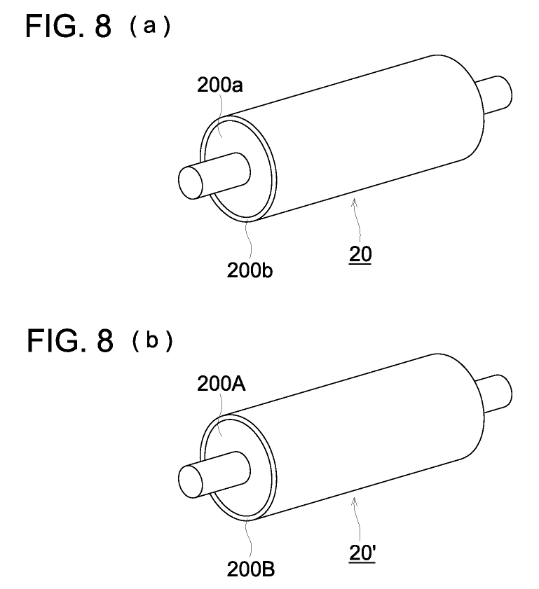

FIG. 8(a) and FIG. 8(b) each are a schematic diagram showing an example of the roll electrode.

The structure of roll electrode 20 will be described below. As shown in FIG. 8(a), roll electrode 20 is constructed with conductive base material 200a (hereinafter, referred to also as “electrode base material”) made of metal or the like, onto which ceramic-coated dielectric material 200b (hereinafter, also referred to simply as “dielectric material”) which has been subjected to a sealing treatment with an inorganic material after thermally spraying is coated. As the ceramic material to be used for spraying, alumina, silicon nitride or the like is preferably used, but alumina is specifically preferable in view of easy workability.

Further, as shown in FIG. 8(b), roll electrode 20′ may be constructed with conductive base material 200A made of metal or the like onto which lining-treated dielectric material 200B fitted with an inorganic material by lining is coated. As the lining material, silicate glass, borate glass, phosphate glass, germinate glass, tellurite glass, aluminate glass, vanadate glass or the like is preferably used, but borate glass is specifically preferable in view of easy workability.

Examples of conductive base materials 200a and 200A made of metal or the like include silver, platinum, stainless steel, aluminum, titanium, iron and so forth, but stainless steel is preferable in view of easy workability.

In the present embodiment, a stainless-steel jacket-roll base material (not shown) fitted with a cooling device by using cooling water is employed for base materials 200a and 200A of the roll electrodes.

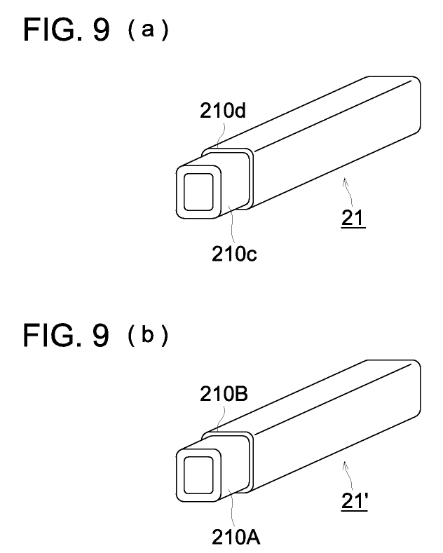

FIG. 9(a) and FIG. 9(b) each are a schematic diagram showing an example of fixed electrodes.

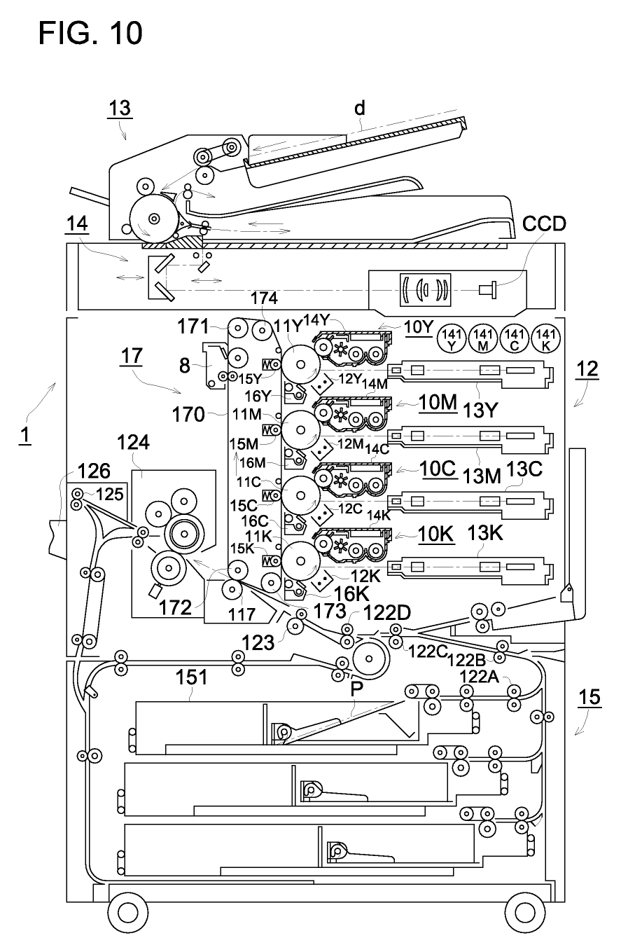

Fixed electrode 21 of a prismatic or rectangular tube is constructed, similarly to the above-described roll electrode 20, with conductive base material 210c made of metal or the like, onto which ceramic-coated dielectric material 200d which has been subjected to a sealing treatment with an inorganic material after thermally spraying is coated, in FIG. 9(a). Further, as shown in FIG. 10(b), fixed electrode 21′ of a prismatic or rectangular tube may be constructed with conductive base material 210A made of metal or the like, onto which lining-processed dielectric material 210B fitted with an inorganic material by lining is coated.

An example of a film-forming process in which surface layer 176 is formed and deposited on substrate 175 among processes in a method of manufacturing an intermediate transfer member will be described below, referring to FIGS. 5 and 7.

Substrate 175 is tension-supported around roll electrode 20 and driven roller 201, then a predetermined tension is applied to substrate 175 via operation of tension-providing unit 202, and thereafter, roll electrode 20 is rotationally driven at a predetermined rotation speed in FIGS. 5 and 7.

Mixed gas supply device 24 produces mixed gas G and mixed gas G is introduced into electric discharge space 23.

A voltage of frequency ω1 is output from first power supply 25 to be applied to fixed electrode 21, and a voltage of frequency ω2 is output from second power supply 26 to be applied to roll electrode 20. These voltages generate electric field V in discharge space 23 with frequency ω1 and frequency ω2 superposed with each other.

Mixed gas G introduced into discharge space 23 is excited by electric field V to make a plasma state. Then, the surface of the substrate is exposed to mixed gas G in the plasma state, and surface layer 176 possessing at least one layer selected from an inorganic oxide film, an inorganic nitride film and an inorganic carbide film is formed on substrate 175 employing a raw material gas in mixed gas G.

In such a manner, the resulting surface layer may be a surface layer composed of plural layers, but at least one layer among the plural layers preferably contains carbon atoms in an amount of 0.1-20% by weight determined via XPS measurement of the carbon atom content.

For example, in the above-described atmospheric pressure plasma CVD apparatus 3, the mixed gas (discharge gas) is plasma-excited between a pair of electrodes (roll electrode 20 and fixed electrode 21), and a raw material gas containing carbon atoms existing in this plasma is radicalized to expose the surface of substrate 175 thereto. Upon the surface of substrate 175 exposed to carbon-containing molecules and carbon-containing radicals, they are contained in the surface layer.

A discharge gas refers to a gas being plasma-excited in the above described conditions, and can be nitrogen, argon, helium, neon, krypton, xenon or a mixture thereof. Nitrogen, helium and argon are preferably used among them and nitrogen is preferable because of low cost.

As a raw material gas to form a surface layer, an organometallic gas being in a gas or liquid state at room temperature is used, and an alkyl metal compound, a metal alkoxide compound and an organometallic complex compound are specifically used. The phase state of these raw materials is not necessarily a gas phase at normal temperature and pressure. A raw material capable of being vaporized through melting, evaporating, sublimation or the like via heating or reduced pressure with mixed gas supply device 24 can be used either in a liquid phase or solid phase.

The raw material gas is one being in a plasma state in discharge space and containing a component to form a thin film, and is an organometallic compound, an organic compound, an inorganic compound or the like.

Examples of silicon compounds include silane, tetramethoxysilane, tetraethoxysilane (TEOS), tetra-n-propoxysilane, tetra-iso-propoxysilane, tetra-n-butoxysilane, tetra-t-butoxysilane, dimethyldimethoxysilane, dimethyldiethoxysilane, diethyldimethoxysilane, diphenyldimethoxysilane, methyltriethoxysilane, ethyltrimethoxysilane, phenyltriethoxysilane, (3,3,3-trifluoropropyl)trimethoxysilane, hexamethyldisiloxane, bis(dimethylamino)dimethylsilane, bis(dimethylamino)methylvinylsilane, bis(ethylamino)dimethylsilane, N,O-bis(trimethylsilyl)acetamide, bis(trimethylsilyl)carbodiimide, diethylaminotrimethylsilane, dimethylaminodimethylsilane, hexamethyldisilazane, heaxamethylcyclotrisilazane, heptamethylsilazane, nonamethyltrisilazane, octamethylcyclotetrasilazane, tetrakisdimethylaminosilane, tetraisocyanatesilane, tetramethyldisilazane, tris(dimethylamino)silane, triethoxyfluorosilane, allyldimethylsilane, allyltrimethylsilane, benzyltrimethylsilane, bis(trimethylsilyl)acetylene, 1,4-bistrimethylsilyl-1,3-butadiine, di-t-butylsilane, 1,3-disilabutane, bis(trimethylsilyl)methane, cyclopentadiphenyltrimethylsilane, phenyldimethylsilane, phenyltrimethylsilane, propagyltrimethylsilane, tetramethylsilane, trimethylsilylacetylene, 1-(trimethylsilyl)-1-propine, tris(trimethylsilyl)methane, tris(trimethylsilyl)silane, vinyltrimethylsilane, hexamethyldisilane, octamethylcyclotetrasiloxane, tetramethylcyclotetrasiloxane, hexamethylcyclotetrasiloxane and M-silicate 51, but are not limited thereto.

Examples of titanium compounds include organometallic compounds such as tetradimethylamino titanium and so forth; metal hydrogen compounds such as monotitanium, dititanium and so forth; metal halogenated compounds such as titanium dichloride, titanium trichloride, titanium tetrachloride and so forth; and metal alkoxides such as tetraethoxy titanium, tetraisopropoxy titanium, tetrabutoxy titanium and so forth, but are not limited thereto.

Examples of aluminum compounds include aluminum n-butoxide, aluminum s-butoxide, aluminum t-butoxide, aluminum diisopropoxide ethylacetoacetate, aluminum ethoxide, aluminum hexafluoropentanedionato, aluminum isopropoxide, aluminum 2,4-pentanedionato, dimethyl aluminum chloride and so forth, but are not limited thereto.

Further, the above-described raw material may be used singly, or by mixing components of at least two kinds.

Hardness of the surface layer can be adjusted by a film-forming rate, an addition gas amount ratio, and so forth.

Surface layer 176 is formed on the surface of support 175 to provide an intermediate transfer member exhibiting high transferability together with high cleaning ability and durability.

A toner employed in this invention will be described.

The toner used in this invention is prepared by a method in which toner mother particles are prepared by coagulation and fusion of resin particles containing a releasing agent and resin and a colorant, and abrasive material particles having specific particle diameter are adhered to the toner mother particles in a specific amount.

Preparation method of toner mother particles, preparation of toner, glass transition point and abrasive material particles are described.

### Preparation Method of Toner Mother Particles

A preparation method of emulsion association is used for the preparation of the toner mother particles. A method is employed concretely in which toner mother particles are prepared by association (coagulation and fusion) of resin particles prepared by emulsion polymerization employing a multi-step polymerization of mini-emulsion polymerization particles.

An example of preparation method of toner mother particles by mini-emulsion polymerization association method is described. The toner mother particles are prepared by the following process.
(1) Dissolution/dispersion process in which a releasing agent is dissolved or dispersed in radical polymerizable monomers.
(2) Polymerization process in which polymerizable monomer dissolving or dispersing the releasing agent therein is made droplets in an aqueous medium, then dispersion of resin particles is prepared by mini-emulsion polymerization.
(3) Coagulation/fusion process in which associated particles are obtained by associating resin particles in the aqueous medium.
(4) Ripening process in which toner mother particles are prepared by ripening associated particles with thermal energy to control their shapes.
(5) Cooling process in which dispersion liquid of the toner mother particles is cooled.
(6) Washing process in which toner mother particles are separated from cooled toner mother particles dispersion liquid and surfactant or so is removed.
(7) Drying process in which the washed toner mother particles are dried.

Each step is described.

### (1) Dissolution/Dispersion Process

A releasing agent is dissolved or dispersed in radical polymerizable monomers, and radical polymerizable monomer liquid containing the releasing agent is prepared in this process.

### (2) Polymerization Process

Polymerizable monomer dissolving or dispersing the releasing agent therein is added to an aqueous medium containing a surfactant, droplets is formed by applying mechanical force, then polymerization is progressed by a radical from water soluble radical polymerization initiator in one preferable example of this process. Resin particles may be added in the aqueous medium as the nuclear particles.

Resin particles containing a releasing agent and a binding resin are obtained by this process. The resin particles maybe colored particles or non-colored particles. The colored particles are obtained by polymerizing monomer component containing colorant. Toner mother particles may be made by coagulating the resin particles and colorant wherein colored particle dispersion is added to resin particle dispersion at a coagulation process described later, in case that the non-colored resin particles are employed.

### (3) Coagulation/Fusion Process

Toner mother particles are formed in this process by employing colored or non-colored resin particles obtained by polymerization process and colorant particles. Particles of intra additives such as a releasing agent or charge controlling agent may be coagulated as well as resin particles and the colorant particles in this coagulation/fusion process.

Colorant particles may be prepared by dispersing colorant in an aqueous medium. Dispersion process of the colorant is conducted in such a condition that the surfactant concentration is set critical micelle concentration (CMC) or more in water. Examples of the dispersion machine employed in this process include a ultrasonic dispersion machine, a mechanical homogenizer, a pressure dispersing machine such as Manton Gaurin or pressure homogenizer, a medium dispersion machine such as a sand grinder, Getzman Mill and a diamond fine mill.

A salting out agent composed of alkali metal salt or alkali earth metal salt is added as a coagulant of concentration not less than critical micelle concentration to an aqueous medium containing resin particles and colorant particles, then fusion is conducted at not less than a glass transition point of the resin particles in the preferable coagulation/fusion process.

### (4) Ripening Process

Ripening is preferably conducted by applying thermal energy (heating). Liquid containing associated particles is agitated with heating and toner mother particles are obtained by arranging heating temperature, agitation speed and heating period, so as to have the shape of the associated particles with necessary shape factor

### (5) Cooling Process

Dispersion liquid of toner mother particles is cooled (rapidly) in this process. Cooling condition is 1-20° C./min. Cooling is conducted in such a way as introducing coolant from outside of reaction vessel, introducing cool water directly into reaction system.

### (6) Washing Process

This process includes separation step in which toner mother particles are separated from liquid of dispersion cooled down to predetermined temperature in the preceding process, and washing step in which unnecessary substance such as a surfactant or a salting out agent is removed from the separated toner cake which is coagulated toner mother particles in a cake shape.

Washing is conducted until the electric conductivity of filtrate reaches 10 mS/cm. Filtering method includes centrifugal separation, reduced pressure filtration employing a Buchner funnel, filtering employing filter press.

### (7) Drying Process

This process is one in which the washed toner cake is dried to prepare dried colored particles. Examples of driers employed preferably in this process include a spray drier, a vacuum freeze drier, and a vacuum drier, and further the stationary tray drier, transportable tray drier, fluid layer drier, rotary type drier, and stirring type drier may be employed. The moisture in the dried colored particles is preferably at most 5% by weight, more preferably 2% by weight. In addition, when the dried colored particles are aggregated via weak attractive force among themselves, the aggregates may be pulverized. Herein, mechanical pulverizing apparatuses such as a jet mill, a HENSCHEL mixer, a coffee mill, or a food processor may be employed as a pulverizing method.

### Preparation of Toner

Toner is prepared by mixing abrasive material particles with the toner mother particles whereby the abrasive material particles are adhered to the toner mother particles.

A mixing apparatus may be used to adhere the abrasive material particles to the toner mother particles, example of the apparatus including a tabular mixer, a Henschel mixer, a Nauter mixer or a V-shape mixer.

An amount of the abrasive material particles adhered on the toner mother particles is preferably 0.1-2.0 parts by weight of 100 parts by weight of the toner mother particles, in view of sufficient function to remove filming, and preventing abrasion of the surface of the intermediate transfer material and preventing generation of edge injure of the cleaning blade. An amount of the abrasive particles adhered on the mother particles can be controlled by adding amount and mixing strength. For example, it is controlled by circumferential speed in case that HENSCHEL MIXER is employed. The higher circumferential speed is employed, the higher ratio of added abrasive particles are adhered to the toner mother particles.

The toner has a glass transition point (Tg) of preferably 20-45° C., and more preferably 20-40° C.

Toner having such Tg as described above has no problem in heat resist storage and is excellent in low temperature fixing property.

Species and amount of polymerizable monomers are controlled so as to obtain the Tg of 20-45° C. Propyl acrylate, propylmethacrylate, butylacrylate, 2-ethyhexylacrylate and laurylacrylate are example of polymerizable monomers to give lower Tg resin, and styrene, methylmethacrylate and methacrylic acid are example of polymerizable monomers to give higher Tg resin.

The glass transition point of the toner can be measured by employing, for example, “DSC-7 DIFFERENTIAL CALORIMETER” (produced by Perkin Elmer Corp.) or “TAC7/DX THERMAL ANALYSIS UNIT CONTROLLER” (produced by Perkin Elmer Corp.).

In practice, about 4.5 to 5.0 mg of toner was collected and its weight was determined down to an accuracy of 0.01 mg. The resultant sample was sealed in an aluminum pan (KIT No. 0219-0041) and placed in a DSC-7 sample holder. An empty aluminum pan was employed for the reference measurement. The measurement was conducted with heat-cool-heat temperature control, in which the conditions are: a measurement temperature of 0-200° C., a temperature rising rate of 10° C./minute, and a temperature cooling rate of 10° C./minute, with temperature control of “Heat-Cool-Heat” mode, and analysis was carried out based on data during the 2nd heating.

The glass transition temperature is obtained as follows. An extension of the base line prior to elevation of the first endothermic peak and a tangential line, which exhibits the maximum inclination between the first peak elevation position and the peak top, are drawn and the resulting intersection is regarded as the glass transition point.

### Particles (A)

The toner of the present invention includes particles (A). The particles (A) are added to toner mother particles for achieving the purpose of the present invention. The particles (A) can be alternatively called as abrasive material particles in such respect. The particles(A) used in this invention are inorganic fine particles having Mohs' scale of hardness of 5 or more, a number average primary particle diameter of 80-300 nm, or inorganic/organic composite particles described later.

Sufficient effect to remove filming can be attained by employing abrasive material particles having Mohs' scale of hardness of 5 or more.

Mohs' scale of hardness shows a relative hardness index measured by generation of wound by rubbing a sample with 10 reference minerals including the lowest hardness of talc (hardness 1) to the highest hardness of diamond (hardness 10).

Filming removing effect is sufficiently exhibited by employing the abrasive material particles having a number average primary particle diameter of 80 nm or less, and abrasion of the surface of the intermediate transfer material and preventing generation of edge injure of the cleaning blade are prevented by employing the abrasive material particles having a number average primary particle diameter of 300 nm or less. Preferable number average primary particle diameter is 20-250 nm.

The number average primary particle diameter can be obtained by measuring long axis of 200 particles photographed by the transmission electron microscope.

The number average primary particle diameter of the abrasive material particles adhered to toner particles in the following way.

Microscopic photograph of toner images of 30,000 magnifying power is read in by scanner. Image of abrasive material particles adhered to toner particles is digitized by an image processing analyzer LUZEX AP, manufactured by Nireco Corp, then horizontal FERE diameters of 200 abrasive material particles are measured and calculate their average to obtain a number average primary particle diameter.

Examples of the usable inorganic particles having Mohs' scale of 5 or more include calcium titanate, barium titanate, magnesium titanate, strontium titanate, cerium dioxide, zirconium oxide, titanium oxide, aluminum titanate, boron carbide, silicon carbide, silicon oxide, calcium zirconate and diamond. Strontium titanate is employed particularly preferably,

The usable inorganic/organic composite particles are those prepared by adhering inorganic fine particles having Mohs' scale of 5 or more to organic particles fixedly.

The inorganic/organic composite particles are composed of organic particles having elasticity in core portion and inorganic fine particles having high hardness adhered to the surface of the organic particles fixedly. The inorganic/organic composite particles exhibit stable cleaning property without accelerating abrasion of the intermediate transfer material and injuring the intermediate transfer material or a cleaning blade by employing organic particles having elasticity in core portion.

A number average primary particle diameter of the inorganic/organic composite particles is preferably 5-100 nm in view of improving cleaning property, abrasion property and anti-filming property. The number average primary particle diameter of the inorganic/organic composite particles is a number based average particle diameter of the particles observed by a scanning electronmicroscope and measured by image analyzer.

Inorganic material used in the inorganic/organic composite particles includes silicon oxide, titanium oxide, aluminum oxide, zinc oxide, zirconium oxide, cerium dioxide, tungsten oxide, antimony oxide, copper oxide, tellurium oxide manganese oxide, barium titanate, strontium titanate, magnesium titanate, silicon nitride, and carbon nitride.

Organic particles composing the inorganic/organic composite particles are preferably resin particles composed of acryl type polymer, styrene type polymer styrene-acryl polymer and so on.

The inorganic fine particles may be adhered to the organic particles by a method in which the organic particles and inorganic fine particles are mixed and then heat is applied to, or so called mechano-chemical method in which the inorganic fine particles are fixedly adhered to the organic particles mechanically. Practically the organic particles and inorganic fine particles are mixed with agitation by Henschel mixer, V type mixer, tabular mixer or so, whereby the inorganic fine particles are made adhered to the surface of the organic particles electrostatically, then the adhered particles are put into thermal processor such as microatomizer and spray dryer and the inorganic fine particles are made soften by heating and are allowed to adhere fixedly to the organic particles on the surface of the organic particles. The other method is that the inorganic fine particles are adhered to the surface of the organic particles electrostatically, then the inorganic fine particles are fixedly adhered to the surface of the organic particles by an apparatus endowing mechanical energy such as Angu mill, hybridizer or so.

The inorganic fine particles are used such an amount that the inorganic fine particles covers the surface of the organic particle uniformly. Practically the inorganic fine particles of 5-100% commonly, preferably 5-80% by weight to the organic particles are used, which depends on the gravity of the inorganic fine particles. When the amount of the inorganic fine particles are too small, cleaning property may becomes insufficient, and when it is in excess the inorganic fine particles may be released from the organic particles.

An image forming apparatus fitted with an intermediate transfer member of this invention will be described.

FIG. 10 is a cross-sectional schematic view of an example of a color image forming apparatus.

Color image forming apparatus 1 is called a tandem type full-color copier, and is comprised of automatic document conveying device 13, original document reading device 14, plural exposure units 13Y, 13M, 13C and 13K, plural image forming sections 10Y, 10M, 10C and 10K, intermediate transfer member unit 17, sheet feeding unit 15 and fixing device 124.

Around the upper portion of main body 12 of the image forming apparatus, disposed are automatic document conveying device 13 and original document reading device 14. An image of original document d conveyed by automatic document conveying device 13 is reflected and caused to form an image by an optical system of image reading device 14, and the image is read by line image sensor CCD.

An analog signal produced by photoelectric conversion of an image of an original document read by the line image sensor CCD is subjected, in an image processing section (not shown), to analog processing, A/D conversion, shading calibration, image compression processing and the like, thereafter transmitted to exposure units 13Y, 13M, 13C and 13K as digital image data of the respective colors, and then latent images of the image data of the respective colors are formed by exposure units 13Y, 13M, 13C and 13K on photoreceptors 11Y, 11M, 11C and 11K in the form of drum (hereinafter, also referred to as photoreceptors).

Image forming sections 10Y, 10M, 10C and 10K are disposed in tandem in the vertical direction, and an intermediate transfer member (hereinafter, referred to as an intermediate transfer belt) 170, which is a second image carrier being semiconductive and in an endless belt form is arranged on the left side, in the figure, of photoreceptors 11Y, 11M, 11C and 11K.

Intermediate transfer belt 170 of the present invention is driven along the arrow direction through roller 171 which is rotationally driven by a drive unit (not shown).

Image forming section 10Y for forming yellow color images includes charging unit 12Y, exposure unit 13Y, development unit 14Y, primary transfer roller 15Y, and cleaning unit 16Y which are disposed around photoreceptor 11Y.

Image forming section 10M for forming magenta color images includes photoreceptor 11M, charging unit 12M, exposure unit 13M, development unit 14M, primary transfer roller 15M, and cleaning unit 16M.

Image forming section 10C for forming cyan color images includes photoreceptor 11C, charging unit 12C, exposure unit 13C, development unit 14C, primary transfer roller 15C, and cleaning unit 16C.

Image forming section 10K for forming black color images includes photoreceptor 11K, charging unit 12K, exposure unit 13K, development unit 14K, primary transfer roller 15K, and cleaning unit 16K.

Toner supply units 141Y, 141M, 141C and 141K supply new toner to respective development units 14Y, 14M, 14C and 14K.

Primary transfer rollers 15Y, 15M, 15C and 15K are selectively operated by a control unit (not shown) corresponding to the image type, and press intermediate transfer belt 170 against respective photoreceptors 11Y, 11M, 11C and 11K to transfer images on the photoreceptors.

In such a manner, the images in the respective colors formed on photoreceptors 11Y, 11M, 11C and 11K by image forming sections 10Y, 10M, 10C and 10K are sequentially transferred to circulating intermediate transfer belt 170 by primary transfer rollers 15Y, 15M, 15C and 15K so that synthesized color images are formed.

The toner images carried on the surfaces of the photoreceptors are primarily transferred to the surface of the intermediate transfer belt, and the intermediate transfer belt holds the transferred toner image.

Recording sheet P stored in sheet supply cassette 151 is fed by sheet feeding unit 151, then conveyed into secondary transfer roller 117 through plural intermediate rollers 122A, 122B, 122C, 122D and registration roller 123, and then the synthesized toner image on the intermediate transfer member is transferred all together onto recording sheet P by secondary transfer roller 117.

The toner image held on the intermediate transfer member is secondarily transferred onto the surface of the transferred material.

Secondary transfer roller 117 presses recording medium P against intermediate transfer belt 170 only when recording medium P passes through here to perform secondary transferring.

Recording sheet P onto which the color image has been transferred is subjected to a fixing treatment by fixing device 124, and nipped by sheet-ejection rollers 125 to be loaded on sheet-ejection tray 126 equipped outside the apparatus.

Residual toner on intermediate transfer belt 170 having curvature-separated recording sheet P is removed by cleaning unit 8, after the color image is transferred to recording medium P by secondary transfer roller 117.

Herein, the intermediate transfer member may be replaced by a rotatable intermediate transfer drum as described above.

Next, the structure of primary transfer rollers 15Y, 15M, 15C and 15K as first transfer units being in contact with intermediate transfer belt 170, and the structure of secondary transfer roller 117 will be described.

Primary transfer rollers 15Y, 15M, 15C and 15K are formed, for example, by coating the circumferential surface of a conductive core metal of stainless or the like with an outer diameter of 8 mm, with a semiconductive elastic rubber having a thickness of 5 mm and a rubber hardness in an approximate range of 20-70 degrees (Asker hardness C). The semiconductive elastic rubber is prepared by making a rubber material such as polyurethane, EPDM, silicon or the like into a solid state or foam sponge state with a volume resistance in an approximate range of 10⁵-10⁹ Ω·cm, dispersing conductive filler such as carbon, to the rubber material or having the rubber material contain an ionic conductive material.

Secondary transfer roller 117 is formed, for example, by coating a circumferential surface of a conductive core metal of stainless or the like with an outer diameter of 8 mm, with a semiconductive elastic rubber having a thickness of 5 mm and a rubber hardness in an approximate range from 20 to 70 degrees (Asker hardness C). The semiconductive elastic rubber is prepared by making a rubber material, such as polyurethane, EPDM, silicon or the like into a solid state or foam sponge state with a volume resistance in an approximate range of 10⁵-10⁹ Ω·cm, dispersing conductive filler such as carbon, to the rubber material or having the rubber material contain an ionic conductive material.

Recording medium used in this invention is a support to carry toner image, and is usually called as an image support material, a transfer material or transfer paper. Specifically it includes usual paper having various thickness, coated printing paper such as art paper or coated paper, Japanese paper or post card on the market, plastic film such as OHP sheet and textile.

### EXAMPLE

The present invention will now be specifically described referring to examples.

### Preparation of Intermediate Transfer Material

An intermediate transfer material sample was prepared in the following manner.

Preparation of Intermediate Transfer Material 1
Preparation of Substrate

| | | |
|---|---|---|
| Polyphenylenesulfide resin “E2180” | 100 | parts by weight |
| (produced by Toray Co., Ltd.) | | |
| Conductive filler “Furnace #3030B” | 16 | parts by weight |
| (produced by Mitsubishi Chemical Corp.) | | |
| Graft copolymer “MODIPER A4400” | 1 | part by weight |
| (produced by NOF Corp.) | | |
| Lubricant (calcium montanate) | 0.2 | parts by weight |

The above-described composition was put into a single-axis extruder, and molten and kneaded to prepare a resin mixture. The resin mixture was extruded into a seamless belt shape through a ring shaped die having a seamless belt-shaped discharge opening attached at the end of the extruder. The extruded seamless belt-shaped resin mixture was introduced into a cooling cylinder provided at a discharging opening, and cooled and solidified to prepare a seamless cylindrical intermediate transfer belt. The resulting substrate had a thickness of 150 μm.

### Forming Inorganic Layer

An inorganic compound layer of 150 nm thick was formed on this substrate employing a plasma discharge treatment apparatus shown in FIG. 5 to form intermediate transfer material 1.

Examples of the material used for the surface layer were silicon oxide and aluminum oxide. As a usable dielectric covering each electrode fitted into the plasma discharge treatment apparatus in this case, alumina of a thickness of 1 mm was coated on each of both facing electrodes via thermally sprayed ceramic treatment. The spacing between the electrodes was set to 0.5 mm. A metal base material on which a dielectric was coated was prepared in accordance to the stainless steel jacket specification having a cooling function with cooling water, and the plasma discharge treatment was conducted while controlling electrode temperature with cooling water during discharging.

After vapor is produced by heating each raw material, and is mixed and diluted with a discharge gas and a reactive gas which have been preheated in advance to prevent coagulation, the resulting has been supplied into the discharge space.

### (Inorganic Layer of Silicon Oxide Layer)

Discharge gas: N₂ gas

Reactive gas: 19% by volume of O₂ gas, based on the total gas

Raw material gas: 0.4% by volume of tetraethoxysilane (TEOS), based on the total gas

Power supply electric power on the low frequency side {high frequency power supply (50 kHz) manufactured by Shinko Electric Co., Ltd.}: 10 W/cm²

Power supply electric power on the high frequency side {high frequency power supply (13.56 MHz) manufactured by Pearl Kogyo Co., Ltd.}: 5 W/cm²

Film forming rate: 21 nm/sec

### Preparation of Intermediate Transfer Materials 2-5

Intermediate transfer materials 2-5 having inorganic layer thickness shown in Table 1 were prepared in the similar manner of the intermediate transfer material 1 by changing the film forming condition (film forming rate) of the inorganic layer.

### Preparation of Intermediate Transfer Material 6

Intermediate transfer material 6 having inorganic layer thickness of 500 nm were prepared in the similar manner of the intermediate transfer material 1 except that the raw material gas was replaced by aluminum s-butoxide and the film forming condition (film forming rate) of the inorganic layer was changed as shown in Table 1.

### (Aluminum Oxide Layer)

Discharge gas: N₂ gas

Reactive gas: 4.0% by volume of H₂ gas, based on the total gas

Raw material gas: 0.05% by volume of aluminum s-butoxide, based on the total gas

Power supply electric power on the low frequency side {impulse high frequency power supply (100 kHz) manufactured by Haiden Laboratory}: 10 W/cm²

Power supply electric power on the high frequency side {wide band high frequency power supply (40.0 MHz) manufactured by Pearl Kogyo Co., Ltd.}: 5 W/cm²

Film forming rate: 12 nm/sec

### Preparation of Intermediate Transfer Material 7

Intermediate transfer material 7 having thickness of 1,000 nm was prepared in the similar manner of the intermediate transfer material 6 except that the film forming rate 12 nm/sec was changed at 24 nm/sec

### Preparation of Intermediate Transfer Material 8

The Substrate prepared by the above mentioned method was used as the intermediate transfer material as for intermediate transfer material 8.

Preparation condition, contact angle against methylene iodide and surface hardness of each samples of the intermediate transfer material are shown in Table 1.

TABLE 1

| Intermediate | Film | | | | Film | | |
|---|---|---|---|---|---|---|---|
| Transfer | Forming | Discharge | Reaction | Raw Material | Thickness | Contact | Hardness |
| Material No. | Method | Gas | Gas | Gas | (nm) | Angle (**) | (GPa) |
| 1 | CVD | N₂ | O₂ | TEOS (*) | 150 | 45° | 5 |
| 2 | CVD | N₂ | O₂ | TEOS | 100 | 45° | 5 |
| 3 | CVD | N₂ | O₂ | TEOS | 1,000 | 45° | 6 |
| 4 | CVD | N₂ | O₂ | TEOS | 60 | 45° | 4 |
| 5 | CVD | N₂ | O₂ | TEOS | 1,100 | 45° | 6 |
| 6 | CVD | N₂ | H₂ | Aluminum s- | 500 | 31° | 10 |
| | | | | butoxide | | | |
| 7 | CVD | N₂ | H₂ | Aluminum s- | 1,000 | 31° | 11 |
| | | | | butoxide | | | |
| 8 | — | — | — | — | — | 25° | 0.5 |

(*) TEOS: Tetraethoxy silane
(**) Contact Angle against methylene iodide

Film thickness, surface hardness and contact angle against methylene iodide of the surface layer of the prepared sample was measured by a manner as previously described.

### Preparation of Toners

Toner is prepared by the following process.

### Abrasive Material Particles

Abrasive material particles as listed are provided.

Compounds for abrasive material particles, a number average primary particle diameter, and Mohs' scale of hardness are shown in Table 2.

TABLE 2

| Abrasive | | Number average | |
|---|---|---|---|
| Particle | | primary particle | Mohs' scale |
| No. | Compound | diameter (nm) | of hardness |
| 1 | Strontium titanate | 20 | 6 |
| 2 | Strontium titanate | 80 | 6 |
| 3 | Strontium titanate | 220 | 6 |
| 4 | Strontium titanate | 300 | 6 |
| 5 | Strontium titanate | 330 | 6 |
| 6 | Magnesium titanate | 150 | 6 |
| 7 | Calcium zirconate | 150 | 6 |
| 8 | Inorganic/organic | 300 | 5 |
| | particles | | |
| 9 | Acryl particles | 300 | 3 |

The inorganic/organic particles of Abrasive Particle No. 8 are those in which silicon oxide having a number average primary particle diameter of 100 nm in amount of 20% by weight were fixedly adhered to the styrene-acryl resin particles having a number average primary particle diameter of 300 nm.

<Preparation of Resin Particle for Core Particle>

<Preparation of Resin Particle 1 for Core Particle>

(1) First Step Polymerization

The following compounds were charged, and mixed in a reaction vessel on which a stirrer, thermal sensor, cooling tube and nitrogen introducing device were attached.

| | |
|---|---|
| Styrene | 110.9 parts by weight |
| n-butyl acrylate | 52.8 parts by weight |
| Methacrylic acid | 12.3 parts by weight |

Paraffin wax HNP-57, manufactured by Nippon Seiro Co., Ltd. Of 93.8 parts by weight was added thereto and dissolved by heating at 80°0 C. to prepare a polymerizable monomer solution.

A surfactant solution was prepared by dissolving 2.9 parts by weight of sodium polyoxyethylene(2)dodecylether-Sulfate in 1,340 parts by weight of deionized water. The surfactant solution was heated by 80° C. and the above polymerizable monomer solution was poured into it, and the polymerizable monomer solution was dispersed for 2 hours by a mechanical disperser having a circulation pass, CLEARMIX manufactured by M-Technique Co, Ltd., to prepare a dispersion of emulsified particles (oil droplets) having an average particle diameter of 245 nm.

After that, 1,460 parts by weight of deionized water was added and then an initiator solution prepared by dissolving 6 parts by weight of a polymerization initiator (potassium persulfate) in 142 parts by weight of deionized water and 1.8 parts by weight of n-octylmercaptan was added and the temperature was adjusted to 80° C. Polymerization (first step of polymerization) was performed by heating and stirring the system to prepare resin particles which were referred to as Resin Particle C1.

(2) Second Step Polymerization (Formation of Outer Layer)

To the above Resin Particle C1, an initiator solution prepared by dissolving 5.1 parts by weight of potassium persulfate in 197 parts by weight of deionized water was added and a monomer mixture composed of the following polymerizable monomers was dropped spending 1 hour under a temperature condition of 80° C.

| | |
|---|---|
| Styrene | 282.2 parts by weight |
| n-butyl acrylate | 134.4 parts by weight |
| Methacrylic acid | 31.4 parts by weight |
| n-octylmercaptan | 4.93 parts by weight |

After completion of the dropping, the system was heated and stirred for 2 hours for carrying out the second step of polymerization (formation of outer layer). And then the system was cooled by 28° C. to obtain Core Rein Particle 1.

The weight average molecular weight, weight average particle diameter and glass transition point of Core Resin Particle 1 were 21,300, 180 nm and 39° C., respectively.

(Preparation of Core Resin Particle 2)

Core Rein Particle 2 was prepared in the same manner as in Resin Core Particle 1 except that the amounts of the polymerizable monomers in the first polymerization step were changed as follows,

| | |
|---|---|
| Styrene | 90.8 parts by weight |
| n-butyl acrylate | 72.7 parts by weight |
| Methacrylic acid | 12.3 parts by weight |

and the amounts of the polymerizable monomers in the second polymerization step were changed as follows.

| | |
|---|---|
| Styrene | 274.1 parts by weight |
| n-butyl acrylate | 168.6 parts by weight |
| Methacrylic acid | 5.2 parts by weight |

The weight average molecular weight, weight average particle diameter and glass transition point of Core Resin Particle 2 were 22,000, 180 nm and 20.1° C., respectively.

(Preparation of Core Resin Particle 3)

Core Rein Particle 3 was prepared in the same manner as in Core Resin Particle 1 except that the amounts of the polymerizable monomers in the first polymerization step were changed as follows,

| | |
|---|---|
| Styrene | 115.3 parts by weight |
| n-butyl acrylate | 48.4 parts by weight |
| Methacrylic acid | 12.3 parts by weight |

and the amounts of the polymerizable monomers in the second polymerization step were changed as follows.

| | |
|---|---|
| Styrene | 293.4 parts by weight |
| n-butyl acrylate | 123.2 parts by weight |
| Methacrylic acid | 31.4 parts by weight |

The weight average molecular weight, weight average particle diameter and glass transition point of Core Resin Particle 3 were 22,500, 180 nm and 44° C., respectively.

(Preparation of Core Resin Particle 4)

Core Rein Particle 4 was prepared in the same manner as in Core Resin Particle 1 except that the amounts of the polymerizable monomers in the first polymerization step were changed as follows,

| | |
|---|---|
| Styrene | 103.5 parts by weight |
| n-butyl acrylate | 70.4 parts by weight |
| Methacrylic acid | 2.1 parts by weight |

and the amounts of the polymerizable monomers in the second polymerization step were changed as follows.

| | |
|---|---|
| Styrene | 263.4 parts by weight |
| n-butyl acrylate | 179.2 parts by weight |
| Methacrylic acid | 5.4 parts by weight |

The weight average molecular weight, weight average particle diameter and glass transition point of Core Resin Particle 4 were 22,500, 180 nm and 18° C., respectively.

(Preparation of Core Resin Particle 5)

Core Rein Particle 5 was prepared in the same manner as in Core Resin Particle 1 except that the amounts of the polymerizable monomers in the first polymerization step were changed as follows,

| | |
|---|---|
| Styrene | 119.7 parts by weight |
| n-butyl acrylate | 44.0 parts by weight |
| Methacrylic acid | 12.3 parts by weight |

and the amounts of the polymerizable monomers in the second polymerization step were changed as follows.

| | |
|---|---|
| Styrene | 304.6 parts by weight |
| n-butyl acrylate | 112.0 parts by weight |
| Methacrylic acid | 31.4 parts by weight |

The weight average molecular weight, weight average particle diameter and glass transition point of Core Resin Particle 5 were 22,500, 180 nm and 49° C., respectively.

(Preparation of Resin Particle for Shell)

Into a reaction vessel on which a stirrer, thermal sensor, cooling tube and nitrogen introducing device were attached, a surfactant solution composed of 2.0 parts by weight of sodium polyoxyethylene(2)dodecylether sulfate and 3,000 parts by weight of deionized water was charged and the internal temperature was raised by 80° C. while stirring at a stirring rate of 230 rpm under nitrogen gas stream.

An initiator solution prepared by dissolving 10 parts by weight of a polymerization initiator, potassium persulfate, in 200 parts by weight of deionized water was added to the surfactant solution and a polymerizable monomer solution composed of a mixture of the following polymerizable monomers was dropped into the surfactant solution spending 3 hours.

| | |
|---|---|
| Styrene | 528 parts by weight |
| n-butyl acrylate | 176 parts by weight |
| Methacrylic acid | 120 parts by weight |
| n-octylmercaptan | 22 parts by weight |

Completion of the dropping of the polymerizable monomer solution, the system was heated and stirred for 1 hour at 80° C. for progressing polymerization to obtain rein particles. The particles were referred to as Resin Particle for Shell.

The weight average molecular weight, weight average particle diameter and glass transition point of Resin Particle for Shell were 12,000, 120 nm and 53° C., respectively.

(Preparation of Colorant Dispersion)

(Preparation of Colorant Dispersion Bk1)

To 900 parts by weight of 10 weight-percent solution of sodium dodecylsulfate, 100 parts by weight of a colorant Regal 330R, manufactured by Cabot Corp., was gradually added while stirring and dispersed by a stirring apparatus CLEARMIX, manufactured by M-Technique Co., Ltd., to prepare a dispersion of the colorant particles. The dispersion was referred to as Colorant Dispersion Bk1. The average dispersed particle diameter of the colorant particles in the dispersion measured by a dynamic light scattering particle size analyzer Microtrac UPA150, manufactured by Nikkiso Co., Ltd., was 150 nm.

(Preparation of Colorant Dispersion C1)

A colorant dispersion was prepared in the same manner as in Colorant Dispersion Bk1 except that 420 parts by weight of the colorant Regal 330R, manufactured by Cabot Corp., was replace by 210 parts by weight of C. I. Pigment Blue 15:3. The dispersion was referred to as Colorant Dispersion C1. The average dispersed particle diameter of the colorant particles in the dispersion measured by a dynamic light scattering particle size analyzer MICROTRAC UPA150, manufactured by Nikkiso Co., Ltd., was 150 nm.

(Preparation of Colorant Dispersion M1)

A colorant dispersion was prepared in the same manner as in Colorant Dispersion Bk1 except that 420 parts by weight of the colorant Regal 330R, manufactured by Cabot Corp., was replace by 357 parts by weight of C. I. Pigment Red 122. The dispersion was referred to as Colorant Dispersion M1. The average dispersed particle diameter of the colorant particles in the dispersion measured by a dynamic light scattering particle size analyzer Microtrac UPA150, manufactured by Nikkiso Co., Ltd., was 150 nm.

(Preparation of Colorant Dispersion Y1)

A colorant dispersion was prepared in the same manner as in Colorant Dispersion Bk1 except that 420 parts by weight of the colorant Regal 330R, manufactured by Cabot Corp., was replace by 378 parts by weight of C. I. Pigment Yellow 74. The dispersion was referred to as Colorant Dispersion Y1. The average dispersed particle diameter of the colorant particles in the dispersion measured by a dynamic light scattering particle size analyzer Microtrac UPA150, manufactured by Nikkiso Co., Ltd., was 150 nm.

(Preparation of Toner Mother Particle Bk1)

(Salt Out/Fusion (Association/Fusion) Process)

### (Formation of Core)

Into a reaction vessel on which a thermal sensor, cooling tube and nitrogen introducing device were attached, 420.7 parts by weight in terms of solid component of Core Resin Particle 1,900 parts by weight of deionized water and 200 parts by weight of Colorant Particle Dispersion Bk1 were charged and stirred. The temperature of the contents was adjusted at 30° C. and the pH of the liquid was adjusted to 9 by adding a 5 mole/L solution of sodium hydroxide solution.

Then an aqueous solution prepared by dissolving 2 parts by weight of magnesium chloride hexahydrate in 1,000 parts by weight of deionized water was added spending 10 minutes at 30° C. After standing for 3 minutes, the system was heated by 65° C. spending 60 minutes. In such the situation, the diameter of the associated particle was measured by Coulter Multisizer 3, manufactured by Coulter Inc., and an aqueous solution composed of 40.2 parts by weight of sodium chloride and 1,000 parts by weight of deionized water was added for stopping growth of the particles when the volume based median diameter of the particles (D₅₀) becomes 5.5 μm. Furthermore, the ripening was carried out for continuing fusion by heating and stirring for 1 hour at a liquid temperature of 70° C. to form Core 1.

The circular degree of Core 1 measured by FPIA-2100, manufactured by Sysmex Co., Ltd., was 0.930.

(Formation of Shell Layer (Shelling Process))

After that, 50 parts by weight in terms of solid component of Resin Particles for Shell was added at 65° C. and an aqueous solution composed of 2 parts by weight of magnesium chloride hexahydrate and 1,000 parts by weight of deionized water was further added spending 10 minutes and the temperature was raised by 70° C. (shell forming temperature). The system was further stirred for 1 hour for fusing Resin Particles for Shell onto the Core 1. Then ripening was conducted at 75° C. for 20 min. to form a shell layer.

To the system, 40.2 parts by weight of sodium chloride was added and the system was cooled by 30° C. at a cooling rate of 8° C./minute. Thus an aqueous solution containing Toner Mother Particles was obtained.

(Washing and Drying Processes)

The solid component was separated from the aqueous solution containing colored particles by a basket type centrifuge Mark III Model No. 60×40, manufactured by Matsumoto Machine MFG. Co., Ltd., to form a wet cake of colored particles. The wet cake was washed by water using the centrifuge until the electroconductivity of the filtrate becomes 5 μS/cm. After that, the cake was transferred to Flash Jet Dryer, manufactured by Seishin Enterprise Co., Ltd., and dried until the moisture content becomes 0.5% by weight to prepare Colored Particle Bk1. Thus obtained Toner Mother Particle Bk1 had core/shell structure and the volume based median diameter (D₅₀) and Tg thereof were 6.0 μm and 39.5° C., respectively.

(Preparation of Toner Mother Particle Bk2)

Toner Mother Particle Bk2 was prepared in the same manner as in Colored Particle Bk1 except that the resin particle for core to be used for forming the core was replaced by Core Resin Particle 2. The volume based median diameter (D₅₀) and Tg of this particle were each 6.0 μm and 20.5° C., respectively.

(Preparation of Toner Mother Particle Bk3)

Toner Mother Particle Bk3 was prepared in the same manner as in Toner Mother Particle Bk1 except that the resin particle for core to be used for forming the core was replaced by Core Resin Particle 3. The volume based median diameter (D₅₀) and Tg of this particle were each 6.0 μm and 44.5° C., respectively.

(Preparation of Toner Mother Particle Bk4)

Toner Mother Particle Bk4 was prepared in the same manner as in Toner Mother Particle Bk1 except that the resin particle for core to be used for forming the core was replaced by Core Resin Particle 4. The volume based median diameter (D₅₀) and Tg of this particle were each 6.3 μm and 18.8° C., respectively.

(Preparation of Toner Mother Particle Bk5)

Toner Mother Particle Bk5 was prepared in the same manner as in Toner Mother Particle Bk1 except that the resin particle for core to be used for forming the core was replaced by Core Resin Particle 5. The volume based median diameter (D₅₀) and Tg of this particle were each 6.1 μm and 49.5° C., respectively.

(Preparation of Toner Bk1)

To 100% by weight of the above-prepared Colored Particle Bk1, 1.0% by weight of Abrasive Material Particles 1, and 0.8% by weight of hydrophobic silica fine particles having a number average primary particle diameter of 50 nm (a fluidizer) were added and mixed for 25 minutes at a circumference speed of 35 m/sec by a Henschel mixer, manufactured by Mitsui Miike Kakoki Co., Ltd., to prepare Toner Bk1. The glass transition point of Toner Bk1 was 39.5° C. which was the same as that of Toner Mother Particles Bk1.

(Preparation of Toner Bk2)

Toner Bk2 was prepared in the same way as Toner Bk1 except that the Abrasive Material Particles 2 was used in place of Abrasive Material Particles 1 used in Toner Bk1.

(Preparation of Toner Bk3)

Toner Bk3 was prepared in the same way as Toner Bk1 except that the Abrasive Material Particles 3 was used in place of Abrasive Material Particles 1 used in Toner Bk1.

(Preparation of Toner Bk4)

Toner Bk4 was prepared in the same way as Toner Bk1 except that the Abrasive Material Particles 4 was used in place of Abrasive Material Particles 1 used in Toner Bk1.

(Preparation of Toner Bk5)

Toner Bk5 was prepared in the same way as Toner Bk1 except that the Abrasive Material Particles 5 was used in place of Abrasive Material Particles 1 used in Toner Bk1.

(Preparation of Toner Bk6)

Toner Bk6 was prepared in the same way as Toner Bk3 except that the amount of Abrasive Material Particles 3 was changed as 0.1% by weight in place of 1.0% by weight Abrasive Material Particles 3 used in Toner Bk3.

(Preparation of Toner Bk7)

Toner Bk7 was prepared in the same way as Toner Bk3 except that the amount of Abrasive Material Particles 3 was changed as 2.0% by weight in place of 1.0% by weight Abrasive Material Particles 3 used in Toner Bk3. Circumference speed by a Henschel mixer was changed to 40 m/sec.

(Preparation of Toner Bk8)

Toner Bk8 was prepared in the same way as Toner Bk3 except that the amount of Abrasive Material Particles 3 was changed as 0.05% by weight in place of 1.0% by weight Abrasive Material Particles 3 used in Toner Bk3.

(Preparation of Toner Bk9)

Toner Bk9 was prepared in the same way as Toner Bk3 except that the amount of Abrasive Material Particles 3 was changed as 2.5% by weight in place of 1.0% by weight Abrasive Material Particles 3 used in Toner Bk3. Circumference speed by a HENSCHEL MIXER was changed to 45 m/sec.

(Preparation of Toner Bk10)

Toner Bk10 was prepared in the same way as Toner Bk1 except that the Abrasive Material Particles 6 was used in place of Abrasive Material Particles 1 used in Toner Bk1.

(Preparation of Toner Bk11)

Toner Bk11 was prepared in the same way as Toner Bk1 except that the Abrasive Material Particles 7 was used in place of Abrasive Material Particles 1 used in Toner Bk1.

(Preparation of Toner Bk12)

Toner Bk12 was prepared in the same way as Toner Bk1 except that the Abrasive Material Particles 8 in an amount of 1.5% by weight was used in place of Abrasive Material Particles 1 in an amount of 1.0% by weight used in Toner Bk1. Circumference speed by a Henschel mixer was changed to 40 m/sec.

(Preparation of Toner Bk13)

Toner Bk13 was prepared in the same way as Toner Bk2 except that the Toner Mother Particles Bk2 was used in place of Toner Mother Particles Bk1 used in Toner Bk2. The glass transition point of Toner Bk13 was 20.5° C. which was the same as that of Toner Mother Particles Bk2.

(Preparation of Toner Bk14)

Toner Bk14 was prepared in the same way as Toner Bk2 except that the Toner Mother Particles Bk3 was used in place of Toner Mother Particles Bk1 used in Toner Bk2. The glass transition point of Toner Bk13 was 44.5° C. which was the same as that of Toner Mother Particles Bk3.

(Preparation of Toner Bk15)

Toner Bk15 was prepared in the same way as Toner Bk2 except that the Toner Mother Particles Bk4 was used in place of Toner Mother Particles Bk1 used in Toner Bk2. The glass transition point of Toner Bk15 was 18.8° C. which was the same as that of Toner Mother Particles Bk4.

(Preparation of Toner Bk16)

Toner Bk16 was prepared in the same way as Toner Bk2 except that the Toner Mother Particles Bk5 was used in place of Toner Mother Particles Bk1 used in Toner Bk2. The glass transition point of Toner Bk15 was 39.5° C. which was the same as that of Toner Mother Particles Bk5.

(Preparation of Toner Bk17)

Toner Bk17 was prepared in the same way as Toner Bk1 except that the Abrasive Material Particles 9 was used in place of Abrasive Material Particles 1 used in Toner Bk1. Circumference speed by a Henschel mixer was changed to 40 m/sec.

(Preparation of Toner Bk18)

Toner Bk18 was prepared in the same way as Toner Bk1 except that the Abrasive Material Particles was not used. Toner Mother Particles, Abrasive Material Particles and their adding amount and adhered amount of Toner samples are shown in Table 3.

TABLE 3

| | Toner Mother | | Abrasive Material Particles | | | |
|---|---|---|---|---|---|---|
| Toner | Particles | | | Adding | Adhered | Processing |
| No. | No. | Tg (° C.) | No. | amount | amount | Condition |
| Bk1 | Bk1 | 39.5 | 1 | 1.2 | 1.0 | 35 m/sec |
| Bk2 | Bk1 | 39.5 | 2 | 1.2 | 1.0 | 35 m/sec |
| Bk3 | Bk1 | 39.5 | 3 | 1.2 | 1.0 | 35 m/sec |
| Bk4 | Bk1 | 39.5 | 4 | 1.2 | 1.0 | 35 m/sec |
| Bk5 | Bk1 | 39.5 | 5 | 1.2 | 1.0 | 35 m/sec |
| Bk6 | Bk1 | 39.5 | 3 | 0.2 | 0.1 | 35 m/sec |
| Bk7 | Bk1 | 39.5 | 3 | 2.3 | 2.0 | 40 m/sec |
| Bk8 | Bk1 | 39.5 | 3 | 0.1 | 0.05 | 35 m/sec |
| Bk9 | Bk1 | 39.5 | 3 | 2.8 | 2.5 | 45 m/sec |
| Bk10 | Bk1 | 39.5 | 6 | 1.2 | 1.0 | 35 m/sec |
| Bk11 | Bk1 | 39.5 | 7 | 1.2 | 1.0 | 35 m/sec |
| Bk12 | Bk1 | 39.5 | 8 | 1.7 | 1.5 | 40 m/sec |
| Bk13 | Bk2 | 20.5 | 2 | 1.2 | 1.0 | 35 m/sec |
| Bk14 | Bk3 | 44.5 | 2 | 1.2 | 1.0 | 35 m/sec |
| Bk15 | Bk4 | 18.5 | 2 | 1.2 | 1.0 | 35 m/sec |
| Bk16 | Bk5 | 49.5 | 2 | 1.2 | 1.0 | 35 m/sec |
| Bk17 | Bk1 | 39.5 | 9 | 1.7 | 1.5 | 40 m/sec |
| Bk18 | Bk1 | 39.5 | — | — | — | — |

(Preparation of Toner C1 through Toner C18)

Toner C1 through Toner C18 were prepared in the similar way to Toner Bk1 through Toner Bk18, respectively, except that Colored Particle C1 was employed in place of Colored Particle Bk1 used in the Toner Bk1 through Toner Bk18.

(Preparation of Toner M1 through Toner M18)

Toner M1 through Toner M18 were prepared in the similar way to Toner Bk1 through Toner Bk18, respectively, except that Colored Particle M1 was employed in place of Colored Particle Bk1 used in the Toner Bk1 through Toner Bk18.

(Preparation of Toner Y1 through Toner Y18)

Toner Y1 through Toner Y18 were prepared in the similar way to Toner Bk1 through Toner Bk18, respectively, except that Colored Particle Y1 was employed in place of Colored Particle Bk1 used in the Toner Bk1 through Toner Bk18.

Measured result of the glass transition point of each of Toner C1 through Toner C18, Toner M1 through Toner M18, Toner Y1 through Toner Y18 was same as that of Toner Bk1 through Toner Bk18.

<<Preparation of Developer>>

Silicone resin coated ferrite carrier having a volume average median diameter (D₅₀) of 60 nm was mixed with each of the above toners to prepare Developer Bk1 through Developer Bk18, Developer C1 through Developer C18, Developer M1 through Developer M18, and Developer Y1 through Developer Y18 each having a toner concentration of 6% by weight.

### Evaluation

### Evaluation of Fixing Ability

A digital copying machine Bizhub Pro C6500, manufactured by Konica Minolta Business Technologies Inc., prints were employed for evaluation apparatus. The samples of intermediate transfer materials and developers are installed respectively. A solid image of each color was printed setting temperature of the heating roller of the fixing device 150° C.

Fixing strength was measured fixing ratio obtained by tape peeling method mentioned below. Image density was measured by a reflective densitometer RD-918, manufactured by Macbeth Co., Ltd.

### (Tape Peeling Method)

The mending tape peeling method was carried out by the following procedure.

1) The absolute reflective density Do was measured.

2) Mending tape No. 810-3-12, manufactured by Sumitomo 3M, was lightly pasted on the black solid image.

3) The surface of the mending tape was rubbed go and return for 3.5 times with a pressure of 1 kPa.

4) The mending tape was peeled off by a force of 200 g at an angle of 180°.

5) The absolute density D₁ of the image after peeling of the mending tape.

6) The fixing ratio was calculated according to the following formula

Fixing ratio (%)=D₁/D₀×100

A digital copying machine Bizhub Pro C6500, manufactured by Konica Minolta Business Technologies Inc., prints were employed for evaluation apparatus. The samples of intermediate transfer materials and developers are installed respectively.

A sample image having 5% image ratio in each color was printed continuously 10,000 sheets of A4 high quality paper (64 g/m²) at 30° C., 80% RH.

### Filming on the Intermediate Transfer Material

Intermediate transfer material sample was taken out after 10,000 sheets printing and the filming of the surface was observed visually.

### Criteria

AA: No filming on the intermediate transfer material is observed.
A: Slight filming is observed slightly, but there is no problem practical use.
C: Filming is observed on whole surface of the intermediate transfer material is observed, and not accepted practical use.

### Edge Broken of Cleaning Blade

Cleaning blade was taken out after 10,000 sheets printing and the nick of the edge was observed visually.

### Criteria

AA: No nick on the cleaning blade is observed.
A: Small nick is observed slightly, but there is no problem practical use.
C: Nick is observed on whole surface of cleaning blade is observed, and not accepted practically use.

### Empty Line

A cyan solid image with image density of 1.2 and a cyan half-tone image were printed after continuously 10,000 sheets printing of sample image having 5% image ratio in each color, empty line on the cyan image was visually observed.

### Criteria

AA: No empty line on a solid cyan print or half-tone cyan print is observed.
A: Empty line is observed on a half-tone cyan print but not on a solid cyan print.
B: Slight empty line is observed on both a solid cyan print and a half-tone cyan print, but there is no problem practical use.
C: Empty line is observed on both a solid cyan print and a half-tone cyan print, and not accepted practically use.

### Extra Line

A cyan half-tone image with image density of 0.4 and no image sheet were printed after continuously 10,000 sheets printing of sample image having 5% image ratio in each color, empty line on the cyan image was visually observed.

### Criteria

AA: No extra line is observed both on half-tone cyan print or a no image print.
A: Extra line is observed on a half-tone cyan print but not a no image print.
B: Slight extra line is observed on both a solid cyan print and a no image print, but there is no problem practical use.
C: Extra line is observed on both a solid cyan print and a no image print, and not accepted practically use.

The result is summarized in Table 4.

TABLE 4

| | ITM | | Fix ratio (%) | | | | | Edge | Empty | Extra |
|---|---|---|---|---|---|---|---|---|---|---|
| Ex. No. | No. (*) | Toner combination | Y | C | M | Bk | Filming | Nick | Line | Line |
| Ex. 1 | No. 1 | Bk2/Y2/M2/C2 | 92.6 | 92.4 | 93.2 | 91.6 | A | AA | A | A |
| Ex. 2 | No. 1 | Bk3/Y3/M3/C3 | 92.8 | 91.8 | 92.8 | 91.3 | AA | AA | AA | AA |
| Ex. 3 | No. 1 | Bk4/Y4/M4/C4 | 92.1 | 92.0 | 92.3 | 91.4 | AA | A | AA | A |
| Ex. 4 | No. 1 | Bk6/Y6/M6/C6 | 93.4 | 93.0 | 93.2 | 93.8 | A | AA | B | A |
| Ex. 5 | No. 1 | Bk7/Y7/M7/C7 | 93.1 | 92.8 | 93.0 | 92.1 | A | AA | A | A |
| Ex. 6 | No. 1 | Bk10/Y10/M10/C10 | 92.3 | 92.3 | 93.1 | 91.3 | AA | AA | AA | AA |
| Ex. 7 | No. 1 | Bk11/Y11/M11/C11 | 92.4 | 92.1 | 92.8 | 91.2 | AA | AA | AA | AA |
| Ex. 8 | No. 1 | Bk12/Y12/M12/C12 | 92.4 | 92.1 | 92.6 | 91.2 | AA | AA | AA | AA |
| Ex. 9 | No. 1 | Bk13/Y13/M13/C13 | 99.8 | 99.5 | 99.2 | 97.8 | A | AA | B | AA |
| Ex. 10 | No. 1 | Bk14/Y14/M14/C14 | 87.1 | 87.7 | 88.3 | 86.3 | AA | AA | AA | AA |
| Ex. 11 | No. 1 | Bk15/Y15/M15/C15 | 99.2 | 99.7 | 99.8 | 99.8 | A | AA | B | AA |
| Ex. 12 | No. 1 | Bk16/Y16/M16/C16 | 82.3 | 80.8 | 83.8 | 81.6 | AA | AA | AA | AA |
| Ex. 13 | No. 2 | Bk3/Y3/M3/C3 | 92.8 | 91.8 | 92.8 | 91.3 | A | AA | A | A |
| Ex. 14 | No. 3 | Bk3/Y3/M3/C3 | 92.8 | 91.8 | 92.8 | 91.3 | AA | AA | AA | A |
| Ex. 15 | No. 6 | Bk3/Y3/M3/C3 | 92.8 | 91.8 | 92.8 | 91.3 | A | A | B | B |
| Comp. 1 | No. 1 | Bk1/Y1/M1/C1 | 93.2 | 92.8 | 93.0 | 92.4 | C | AA | A | B |
| Comp. 2 | No. 1 | Bk5/Y5/M5/C5 | 92.2 | 91.8 | 92.6 | 91.1 | C | A | B | C |
| Comp. 3 | No. 1 | Bk8/Y8/M8/C8 | 92.6 | 92.0 | 92.1 | 91.6 | C | AA | C | C |
| Comp. 4 | No. 1 | Bk9/Y9/M9/C9 | 92.2 | 91.2 | 91.9 | 90.2 | C | A | B | B |
| Comp. 5 | No. 4 | Bk3/Y3/M3/C3 | 92.8 | 91.8 | 92.8 | 91.3 | C | AA | C | AA |
| Comp. 6 | No. 5 | Bk3/Y3/M3/C3 | 92.8 | 91.8 | 92.8 | 91.3 | C | C | AA | C |
| Comp. 7 | No. 1 | Bk17/Y17/M17/C17 | 91.2 | 92.2 | 93.8 | 94.3 | C | A | C | A |
| Comp. 8 | No. 1 | Bk18/Y18/M18/C18 | 91.2 | 92.2 | 93.8 | 94.3 | C | A | C | A |
| Comp. 9 | No. 7 | Bk3/Y3/M3/C3 | 92.8 | 91.8 | 92.8 | 91.3 | C | C | A | C |
| Comp. 10 | No. 8 | Bk3/Y3/M3/C3 | 92.8 | 91.8 | 92.8 | 91.3 | C | A | C | A |

(*) Intermediate Transfer Material No.

Examples 1-15 all demonstrate good result in all evaluation items and confirmed that the advantage of this invention attains. Comparative Examples 1-10 does not demonstrate in one or more evaluation items.

What is claimed is:

1. An image forming method comprising steps of:
forming a toner image on a photoreceptor,
primary transferring the toner image on the photoreceptor to an intermediate transfer material,
secondary transferring the toner image on intermediate transfer material to a transfer material, and
cleaning remaining toner on the photoreceptor,
wherein the toner comprises particles (A) adhered to a toner mother particle comprising a resin and a colorant, in which a number average primary particle diameter of the particles (A) is 80-300 nm and Mohs' hardness of 5 or more, and an amount of the particles (A) is 0.1-2.0 parts by weight of 100 parts by weight of the toner mother particles, and,
the intermediate transfer material comprises a substrate and an inorganic layer provided on the substrate, and the inorganic layer has a hardness measured by nanoindentation method of 3-10 GPa.

2. The image forming method of claim 1, wherein a glass transition point of the toner is 20-45° C.

3. The image forming method of claim 1, wherein the substrate of the intermediate transfer material is a seamless belt or a drum, composed of resin material in which an electroconductive material is dispersed.

4. The image forming method of claim 1, wherein the inorganic layer is a silicon oxide or metal oxide layer.

5. The image forming method of claim 1, wherein a contact angle of a surface of the inorganic layer measured against methylene iodide is 30-60°.

6. The image forming method of claim 1, wherein the inorganic layer comprises at least one of silicon oxide, silicon nitride oxide, silicon nitride, titanium oxide, titanium nitride oxide, titanium nitride and aluminum oxide.

7. The image forming method of claim 1, wherein a thickness of the inorganic layer is 100-1,000 nm.

8. The image forming method of claim 7, wherein the thickness of the inorganic layer is 150-500 nm.

9. The image forming method of claim 8, wherein the thickness of the inorganic layer is 200-400 nm.

10. The image forming method of claim 1, wherein the hardness measured by a nanoindentation method is 4-6 GPa.

11. The image forming method of claim 1, wherein the particles (A) comprise at least one of calcium titanate, barium titanate, magnesium titanate, strontium titanate, cerium dioxide, zirconium oxide, titanium oxide, aluminum titanate, boron carbide, silicon carbide, silicon oxide, calcium zirconate and diamond.

12. The image forming method of claim 1, wherein the particles (A) contains strontium titanate.

13. The image forming method of claim 1, wherein the particles (A) is inorganic/organic composite particles.
